(19) United States
(12) Patent Application Publication
(10) Pub. No.: US 2024/0245126 A1
(43) Pub. Date: Jul. 25, 2024

(54) AEROSOL GENERATING DEVICE FOR SENSING AEROSOL GENERATING ARTICLE AND METHOD OF OPERATING THE SAME

(71) Applicant: KT&G CORPORATION, Daejeon (KR)

(72) Inventors: Yong Hwan KIM, Gyeonggi-do (KR); Dong Sung KIM, Seoul (KR); Hun II LIM, Seoul (KR); Seok Su JANG, Daejeon (KR)

(73) Assignee: KT&G CORPORATION, Daejeon (KR)

(21) Appl. No.: 18/289,236

(22) PCT Filed: Jul. 22, 2022
(86) PCT No.: PCT/KR2022/010802

§ 371 Date: Nov. 2, 2023

(30) Foreign Application Priority Data
Jul. 22, 2021 (KR) 10-2021-0096700

(51) Int. Cl. A24F 40/465; A24F 40/20; A24F 40/51; A24F 40/53; A24F 40/57; A24F 40/60; A24F 40/65

(52) U.S. Cl. CPC A24F 40/465; A24F 40/20; A24F 40/51; A24F 40/57; A24F 40/53; A24F 40/60; A24F 40/65

(57) ABSTRACT

An aerosol generating device according to an embodiment including a housing including a chamber configured to accommodate an aerosol generating article, an induction coil configured to generate a variable magnetic field, a susceptor arranged to surround at least a portion of the chamber and configured to generate heat by the variable magnetic field, a sensor spaced apart from the induction coil in a length direction of the housing and arranged in a region in which the intensity of the variable magnetic field is less than or equal to a designated value, and a processor electrically connected to the induction coil and the sensor. In addition, various examples are available through the specification.

### TECHNICAL FIELD

The present disclosure relates to an aerosol generating device that senses a moisture amount of an aerosol generating article, and a method of operating the aerosol generating device.

### BACKGROUND ART

There has been an increasing demand for a replacement method of overcoming disadvantages of general cigarettes. For example, the demand for a system of generating aerosols is increasing by heating cigarettes or an aerosol generating material by using an aerosol generating device, not a method of generating aerosols by burning cigarettes.

An aerosol generating material included in an aerosol generating article, and a tobacco material may include a certain amount of moisture. However, high-temperature aerosols may be generated when the aerosol generating article is in an excess moisture state. As a result, a user inhales high-temperature aerosols when smoking. Accordingly, the satisfaction of smoking may be disturbed, and the inconvenience due to the high temperature may occur.

### DISCLOSURE

### Technical Problem

Various methods of heating an aerosol generating article have been proposed. Among them, an induction heating method may mean a method of generating an aerosol generating material by heating a metal object (e.g., a susceptor) through electromagnetic induction.

The aerosol generating device in which the induction heating method is adopted, may include a capacitive sensor for measuring a moisture amount of the aerosol generating article. In the capacitive sensor, sensing sensitivity may be reduced due to the influence of a magnetic field generated by an induction coil.

The problems to be solved through embodiments of the present disclosure are not limited to the above-mentioned problems, and problems that are not mentioned will be clearly understood by one of ordinary skilled in the art from the specifications and the accompanying drawings.

### Technical Solution

An aerosol generating device according to an embodiment includes a housing including a chamber configured to accommodate an aerosol generating article, an induction coil configured to generate a variable magnetic field, a susceptor arranged to surround at least a portion of the chamber and configured to generate heat by the variable magnetic field, a sensor spaced apart from the induction coil in a length direction of the housing and arranged in a region in which the intensity of the variable magnetic field is less than or equal to a designated value, and a processor electrically connected to the induction coil and the sensor.

A method of operating an aerosol generating device according to an embodiment includes obtaining a capacitance corresponding to a moisture amount of an aerosol generating article from a sensor arranged in a region in which an intensity of a variable magnetic field generated by an induction coil is less than or equal to a designated value, and controlling the aerosol generating device to supply power to the induction coil based on the obtained capacitance.

### Advantageous Effects

According to various embodiments of the present disclosure, sensing sensitivity to a moisture amount may increase as sensors that detect a moisture amount of an aerosol generating article are arranged at a position where the effect of a magnetic field of an induction coil is minimized.

However, the effects according to embodiments are not limited to the above-mentioned effects, and effects that are not mentioned will be clearly understood by one of ordinary skilled in the art from the specifications and the accompanying drawings.

### DESCRIPTION OF DRAWINGS

FIG. 1 is a perspective view of an aerosol generating device according to an embodiment.

FIG. 2 is a view schematically illustrating elements of an aerosol generating device according to an embodiment.

FIG. 3A is an exemplary diagram showing a state in which the sensor of FIG. 2 is disposed in a first region.

FIG. 3B is an exemplary diagram showing a state in which the sensor of FIG. 2 is disposed in a second region.

FIG. 4 is a block diagram of an aerosol generating device according to an embodiment.

FIG. 5 is a flowchart illustrating a method of controlling power supply by using an aerosol generating device according to an embodiment.

FIG. 6 is a flowchart illustrating a method of controlling power supply based on a capacitance by using an aerosol generating device according to an embodiment.

FIG. 7A is an exemplary diagram for explaining a first method of controlling power supply by using an aerosol generating device according to an embodiment.

FIG. 7B is an exemplary diagram for explaining a second method of controlling power supply by using an aerosol generating device according to an embodiment.

FIG. 8A is an exemplary diagram illustrating a display state when an aerosol generating article in a general state is inserted into an aerosol generating device according to an embodiment.

FIG. 8B is an exemplary diagram illustrating a display state when an aerosol generating article in an excess moisture state is inserted into an aerosol generating device according to an embodiment.

FIG. 9 is a block diagram of an aerosol generating device according to another embodiment.

### BEST MODE

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

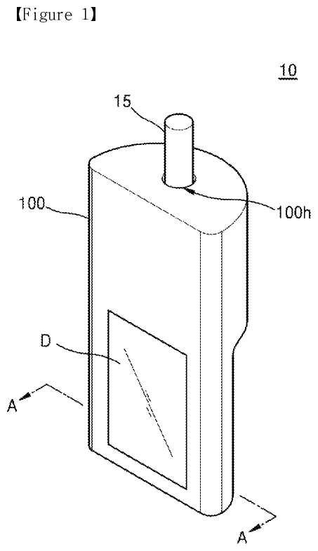

FIG. 1 is a perspective view of an aerosol generating device according to an embodiment.

Referring to FIG. 1, an aerosol generating device 10 according to an embodiment may include a housing 100 into which an aerosol generating article 15 may be inserted.

In an embodiment, the housing 100 may constitute the overall appearance of the aerosol generating device 10 and may include an internal space (or an ‘arrangement space’) in which elements of the aerosol generating device 10 may be arranged. In the drawing, only an embodiment in which the cross-section of the housing 100 is an entirely semicircle shape, is shown. However, the shape of the housing 100 is not limited thereto. According to an embodiment (not shown), the housing 100 may have an entirely cylindrical shape or a polygonal pillar (e.g., a triangular pillar or a rectangular pillar) shape.

According to an embodiment, elements for generating aerosols by heating the aerosol generating article 15 inserted into the housing 100 and elements for sensing a moisture amount of the aerosol generating article 15 may be arranged in the internal space of the housing 100, and a detailed description thereof will be provided below.

According to an embodiment, the housing 100 may include an opening 100h into which the aerosol generating article 15 may be inserted into the housing 100. At least a portion of the aerosol generating article 15 may be inserted into or accommodated in the housing 100 through the opening 100h.

As the aerosol generating article 15 inserted in or accommodated in the housing 100 is heated inside the housing 100, aerosols may be generated. The generated aerosols may be discharged to the outside of the aerosol generating device 10 through the inserted aerosol generating article 20 and/or a space between the aerosol generating article 20 and the opening 100h, and the user may inhale the discharged aerosols.

The aerosol generating device 10 according to an embodiment may further include a display D on which visual information is displayed.

In an embodiment, the display D may be disposed so that at least a region of the display D is exposed to the outside of the housing 100. For example, at least a region of the display D may be exposed through a cover glass outside the housing 100.

The aerosol generating device 10 may provide various visual information to the user through the display D. For example, the aerosol generating device 10 may output a preheating time and a puff number for the aerosol generating article 15 through the display D. Information output through the display D is exemplary and is not limited to the above-described embodiment.

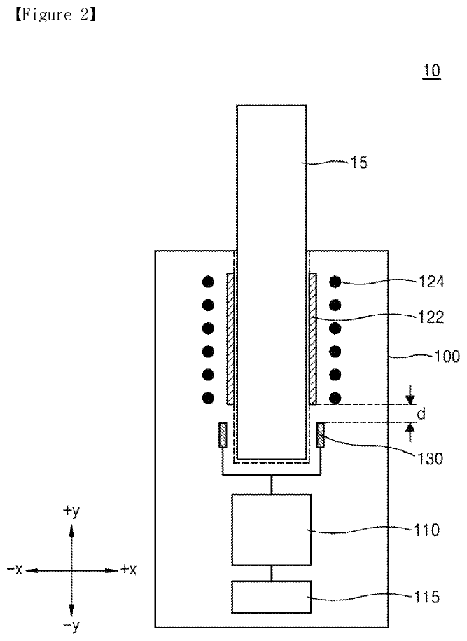

FIG. 2 is a view schematically illustrating elements of an aerosol generating device according to an embodiment. FIG. 2 is a cross-sectional view of the aerosol generating device shown in FIG. 1 taken along line A-A′ so as to explain some elements arranged in a housing in detail.

Referring to FIG. 2, the aerosol generating device 10 may include a housing 100, a processor 110, a susceptor 122, an induction coil 124, and a sensor 130. Elements of the aerosol generating device 10 according to an embodiment are not limited thereto. Other elements may be added, or at least one element may be omitted according to an embodiment.

In an embodiment, the housing 100 may include an accommodation space in which the aerosol generating article 15 may be inserted or accommodated. For example, at least a portion of the aerosol generating article 15 may be inserted into or accommodated in the accommodation space through an opening (e.g., the opening 100h of FIG. 1).

In an embodiment, the aerosol generating device 10 may generate aerosols by heating the aerosol generating article 15 accommodated in the aerosol generating device 10 in an induction heating manner. For example, the aerosol generating device 10 may generate a variable magnetic field by supplying power to the induction coil 124. In this case, at least a portion of the aerosol generating article 15 may be heated by the susceptor 122 heated by the variable magnetic field, and aerosols may be generated as the aerosol generating article 15 is heated.

In an embodiment, the susceptor 122 may surround at least a portion of the outer surface of the aerosol generating article 15 accommodated in the aerosol generating device 10. For example, the susceptor 122 may surround at least a portion of a portion including an aerosol generating material and a portion including a tobacco material.

In an embodiment, the induction coil 124 may be arranged to surround an outer circumferential surface of the susceptor 122 and may generate a variable magnetic field as power is supplied from the battery 115. In an embodiment, in the induction coil 124, an alternating current value A and a frequency value used to heat the susceptor 122 may be preset. For example, for the induction coil 124, the alternating current value A may be set in the range of about 120 mA to about 140 mA, and the frequency value may be set in the range of about 130 KHz to about 150 KHz. However, the alternating current value A and the frequency value of the induction coil 124 are not limited thereto and may be variously changed according to the material, thickness or shape of the susceptor 122.

In an embodiment, the sensor 130 may be spaced apart from at least one of the susceptor 122 and the induction coil 124 in a length direction (e.g., a +y-direction or a −y-direction) of the housing 100. For example, the sensor 130 may be spaced apart from the induction coil 124 in the length direction of the housing 100 by a designated distance d. In this case, the designated distance d may mean a distance from an end point of the induction coil 124 or the susceptor 122 to a point at which the effect of the magnetic field generated by the induction coil 124 is minimized.

In an embodiment, the sensor 130 may be arranged in a region in which the intensity of the variable magnetic field generated by the induction coil 124 is less than or equal to a designated value. For example, the designated value may mean a maximum value of the intensity of the variable magnetic field in which sensing sensitivity of the sensor 130 is not substantially reduced. The designated value may be in the range of about 10 μT to about 100 μT but is not limited thereto.

In an embodiment, the sensor 130 may be a capacitive sensor that senses a capacitance. For example, the sensor 130 may sense the capacitance corresponding to the moisture amount of the aerosol generating article 15. The dielectric properties between the sensors 130 may change differently according to the moisture amount of the aerosol generating article 15, and the sensor 130 may detect the capacitance based on the dielectric properties. In an embodiment, as the sensor 130 that is a capacitive sensor is spaced apart from the induction coil 124 by the designated distance d, the sensor 130 may be affected by the magnetic field at a minimum. That is, the sensor 130 may be spaced apart from the induction coil 124 by the designated distance d so as not to substantially over lap a region of a high-frequency magnetic field generated by the induction coil 124. Through the arrangement structure of the sensor 130, the sensing sensitivity of the sensor 130, which detects the capacitance, may be prevented from being significantly lowered by the high-frequency magnetic field.

In an embodiment, the sensor 130 may include at least one electrode formed of a metal thin film. For example, the sensor 130 may include at least one electrode formed of a copper foil.

In an embodiment, the processor 110 may sense the capacitance generated by the sensor 130 and may supply power to the induction coil 124 based on the sensed capacitance. However, a detailed description thereof will be provided below.

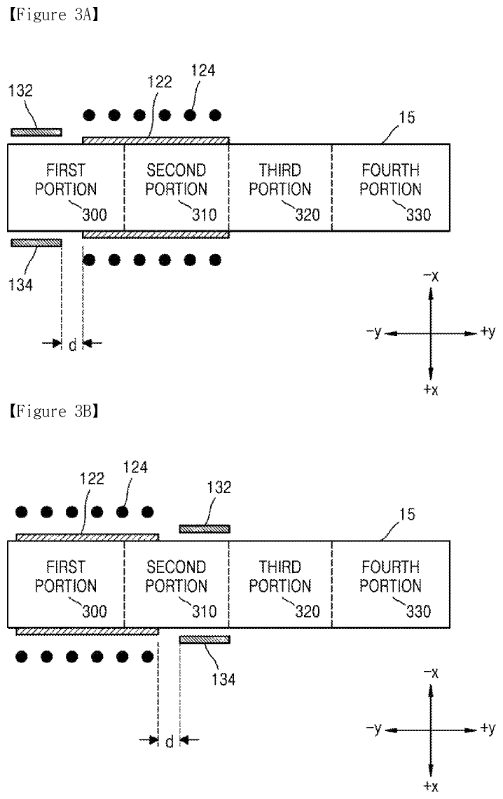

FIG. 3A is an exemplary diagram showing a state in which the sensor 130 of FIG. 2 is disposed in a first region. In the present disclosure, the ‘first region’ may mean one region of the housing 100 spaced apart from the susceptor 122 and/or the induction coil 124 in the −y-direction. Also, the ‘first region’ may mean a region adjacent to at least a portion of a first portion 300 of the aerosol generating article 15 when the aerosol generating article 15 is accommodated in an accommodation portion.

Referring to FIG. 3A, a sensor (e.g., the sensor 130 of FIG. 2) may include a first electrode 132 and a second electrode 134. For example, the sensor 130 may detect the capacitance according to the moisture amount of the aerosol generating article 15 arranged between the first electrode 132 and the second electrode 134.

In an embodiment, the first electrode 132 and the second electrode 134 may be spaced apart from at least one of the susceptor 122 and the induction coil 124 in a first direction (e.g., −y-direction) parallel to a length direction of a housing (e.g., the housing 100 of FIG. 2). In the present disclosure, the ‘first direction’ may mean a reverse direction to a direction in which an aerosol flows in the aerosol generating article 15 as a user puffs.

In an embodiment, the aerosol generating article 15 may include a first portion 300, a second portion 310, a third portion 320, and a fourth portion 330. For example, the first portion 300 may include at least one of aerosol generating materials such as glycerine, prophylene glycol, ethylene glycol, diprophylene glycol, diethylene glycol, triethylene glycol, tetraethylene glycol, and oleyl alcohol. The second portion 310 may include at least one of tobacco sheets, tobacco strands, and tobacco materials such as pipe tobacco, which are formed of tiny bits cut from the tobacco sheets, and reconstituted tobacco leaves. The third portion 320 may be a cooling portion that cools aerosols. The fourth portion 330 may be a filter segment including a filter material.

In an embodiment, the first electrode 132 and the second electrode 134 of the sensor 130 may be disposed to correspond to a portion of the first portion 300 including the aerosol generating material. In this case, the first electrode 132 and the second electrode 134 may be spaced apart from at least one of the susceptor 122 and the induction coil 124 by the designated distance d.

In an embodiment, the first portion 300 may include an aerosol generating material in a liquid state. For example, the first portion 300 may be formed in such a way that the aerosol generating material in the liquid state is impregnated into a porous material such as pulp. As the first part 300 includes the aerosol generating material in the liquid state, the largest change in the moisture amount in the aerosol generating article 15 may occur in the first portion 300. Thus, as the first electrode 132 and the second electrode 134 are arranged to correspond to at least a portion of the first portion 300, the sensor 130 may detect the capacitance according to the moisture amount of the aerosol generating article 15 more accurately.

FIG. 3B is an exemplary diagram showing a state in which the sensor of FIG. 2 is disposed in a second region. In the present disclosure, the ‘second region’ may mean one region of the housing 100 spaced apart from the susceptor 122 and/or the induction coil 124 in the ty-direction. Also, the ‘second region’ may mean a region adjacent to at least a portion of the second portion 310 of the aerosol generating article 15 when the aerosol generating article 15 is accommodated in the accommodation portion. In the description of FIG. 3B, the contents corresponding to, the same as or similar to the above-described contents may be omitted.

Referring to FIG. 3B, a sensor (e.g., the sensor 130 of FIG. 2) may include a first electrode 132 and a second electrode 134. For example, the sensor 130 may detect the capacitance according to the moisture amount of the aerosol generating article 15 arranged between the first electrode 132 and the second electrode 134.

In an embodiment, the first electrode 132 and the second electrode 134 may be spaced apart from at least one of the susceptor 122 and the induction coil 124 in a second direction (e.g., ty-direction) parallel to a length direction of a housing (e.g., the housing 100 of FIG. 2). In the present disclosure, the ‘second direction’ may mean a reverse direction to a direction in which an aerosol generated flows in the aerosol generating article 15 as a user puffs.

In an embodiment, the first electrode 132 and the second electrode 134 of the sensor 130 may be disposed to correspond to a portion of the second portion 310 including a tobacco material. In this case, the first electrode 132 and the second electrode 134 may be spaced apart from at least one of the susceptor 122 and the induction coil 124 by the designated distance d.

In an embodiment, the second portion 310 may include a tobacco material in a solid state. For example, the second portion 310 may be formed to include granules, capsules, etc., including the tobacco material as well as pipe tobacco and reconstituted tobacco leaves. In this case, the tobacco material included in the second portion 310 may absorb a certain amount of moisture from a surrounding environment. Thus, as the first electrode 132 and the second electrode 134 are arranged to correspond to at least a portion of the second portion 310, the sensor 130 may detect the capacitance according to the moisture amount of the aerosol generating article 15.

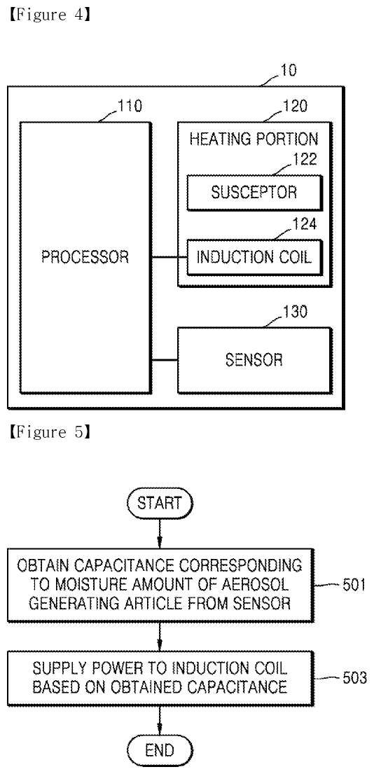

FIG. 4 is a block diagram of an aerosol generating device according to an embodiment.

Referring to FIG. 4, the aerosol generating device 10 may include a processor 110, a heating portion 120, and a sensor 130.

In an embodiment, the sensor 130 may be a capacitive sensor. For example, the sensor 130 may detect a capacitance C corresponding to the moisture amount of an aerosol generating article (e.g., the aerosol generating article 15 of FIG. 1). The capacitance C may be determined according to the distance d between electrodes (e.g., the first electrode 132 and the second electrode 134 of FIGS. 3A and 3B), the area A of the electrodes 132 and 134, and the permittivity ε of a material placed between the electrodes 132 and 134. The capacitance C may be obtained based on [Equation 1].

$$C = ε \frac{A}{d} \qquad [ Equation 1 ]$$

In an embodiment, a capacitance may be generated based on the permittivity ε that varies according to the state of the aerosol generating article 15. For example, the permittivity ε may vary according to the moisture amount of the aerosol generating article 15. The moisture amount of the aerosol generating article 15 may mean the moisture weight with respect to the total weight of a tobacco rod (e.g., the first portion 300 and the second portion 310 of FIGS. 3A and 3B).

In an embodiment, when the aerosol generating article 15 in a general state is disposed between the first electrode 132 and the second electrode 134, a first capacitance may be generated based on the permittivity ε₁ of the aerosol generating article 15. In this case, the general state may mean a state in which the tobacco rod of the aerosol generating article 15 includes moisture of about 15 wt % or less with respect to the total weight of the tobacco rod.

In an embodiment, when the aerosol generating article 15 in an excess moisture state is disposed between the first electrode 132 and the second electrode 134, a second capacitance may be generated based on the permittivity ε₂ of the aerosol generating article 15. In this case, the excess moisture state may mean a state in which the tobacco rod of the aerosol generating article 15 includes moisture of about 15 wt % or more with respect to the total weight of the tobacco rod.

However, the moisture amount for determining the state (e.g., a general state or an excess moisture state) of the aerosol generating article 15 is not limited thereto and may be variously changed according to a manufacturer's design.

In an embodiment, the processor 110 may obtain the capacitance detected through the sensor 130. In this case, the capacitance detected through the sensor 130 may mean a difference between the capacitance values that change depending on the presence of the aerosol generating article 15. For example, when the aerosol generating article 15 is not present in a housing (e.g., the housing 100 of FIG. 2), an initial capacitance Cₚ may be present between a first electrode (e.g., the first electrode 132 of FIGS. 3A and 3B) and a second electrode (e.g., the second electrode 134 of FIGS. 3A and 3B) of the sensor 130. Subsequently, when the aerosol generating article 15 is inserted into the housing 100, a capacitance (Cₚ+C_{f}) obtained by adding a certain capacitance C_{f} to the initial capacitance Cₚ may be present between the first electrode 132 and the second electrode 134 of the sensor 130. That is, the processor 110 may obtain C_{f}, which is a change value of a capacitance depending on the presence of the aerosol generating article 15, from the sensor 130. The processor 110 may obtain the C_{f} through at least one of a charging/discharging time difference, a difference between charging voltages, and a frequency difference with respect to the sensor 130.

In an embodiment, the processor 110 may supply power to the induction coil 124 based on the obtained capacitance. For example, the processor 110 may determine the state of the aerosol generating article 15 by comparing the obtained capacitance with a preset value. The processor 110 may determine whether the aerosol generating article 15 is in a general state or an excess moisture state and may supply power to the induction coil 124 based on a determination result. In this case, ‘power’ may mean power supplied to preheat the aerosol generating article 15 such that the susceptor 122 may be heated up to a preset preheating temperature (e.g., 300° C.) through a magnetic field generated inside the induction coil 124.

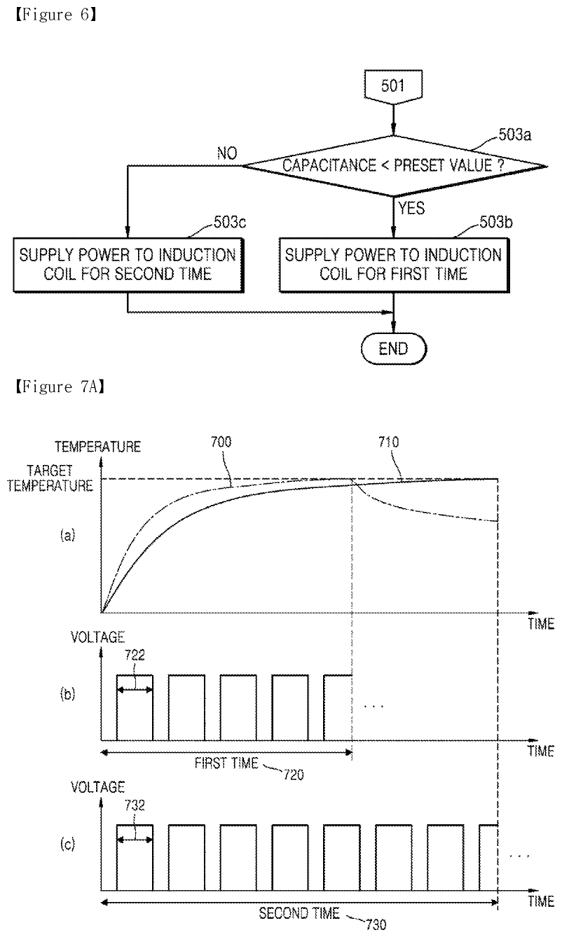

FIG. 5 is a flowchart illustrating a method of controlling power supply by using an aerosol generating device according to an embodiment.

Referring to FIG. 5, a processor (e.g., the processor 110 of FIG. 4) may obtain a capacitance corresponding to the moisture amount of an aerosol generating article (e.g., the aerosol generating article 15 of FIG. 1) from a sensor (e.g., the sensor 130 of FIG. 4) in operation 501.

In an embodiment, the processor 110 may obtain different capacitances according to the state of the aerosol generating article 15 through the sensor 130.

For example, for the aerosol generating article 15 in a general state, the processor 110 may obtain a first capacitance through the sensor 130. In this case, the general state may mean a state in which a tobacco rod (e.g., the first portion 300 and the second portion 310 of FIGS. 3A and 3B) of the aerosol generating article 15 includes moisture of about 15 wt % or less with respect to the total weight of the tobacco rod. Also, the first capacitance may mean a capacitance C_{f} which has increased as the aerosol generating article 15 in the general state is inserted into a housing (e.g., the housing 100 of FIG. 2).

In another example, for the aerosol generating article 15 in an excess moisture state, the processor 110 may obtain a second capacitance through the sensor 130. In this case, the excess moisture state may mean a state in which the tobacco rod of the aerosol generating article 15 includes moisture of about 15 wt % or more with respect to the total weight of the tobacco rods 300 and 310 of the aerosol generating article 15. Also, the second capacitance may mean a capacitance C_{f} that has increased as the aerosol generating article 15 in the excess moisture state is inserted into the housing 100.

According to an embodiment, the processor 110 may supply power to an induction coil (e.g., the induction coil 124 of FIG. 4) based on the capacitance obtained in operation 503. For example, the processor 110 may determine the state of the aerosol generating article 15 by comparing the first capacitance or the second capacitance obtained through the sensor 130 with the preset value. The processor 110 may determine whether the aerosol generating article 15 is in a general state or an excess moisture state and may supply power to the induction coil 124 based on a determination result.

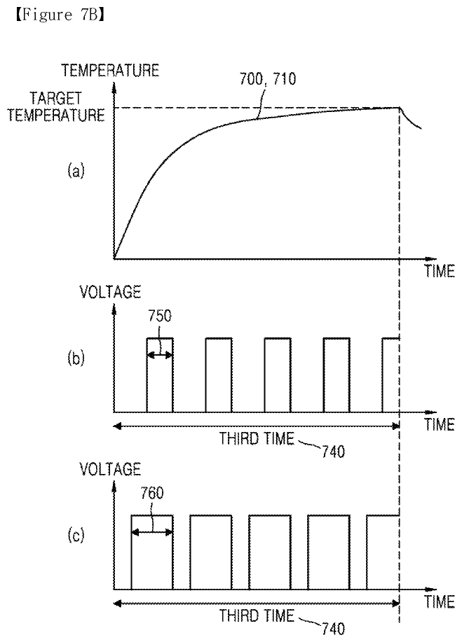

FIG. 6 is a flowchart illustrating a method of controlling power supply based on a capacitance by using an aerosol generating device according to an embodiment. FIG. 6 is a flowchart for explaining operation 503 of FIG. 5 specifically.

Referring to FIG. 6, a processor (e.g., the processor 110 of FIG. 4) may compare the capacitance obtained through the sensor 130 with the preset value in operation 503a. In this case, the preset value may be a minimum value of the capacitance indicating the excess moisture state of the aerosol generating article. In this case, the excess moisture state may mean a state in which a tobacco rod (e.g., the first portion 300 and the second portion 310 of FIGS. 3A and 3B) of the aerosol generating article 15 includes moisture of about 15 wt % or more with respect to the total weight of the tobacco rod. In this case, as the aerosol generating article 15 including the tobacco rod containing moisture of 15 wt % with respect to the total weight of the tobacco rod is inserted into the housing (e.g., the housing 100 of FIG. 2), the processor 110 may obtain a capacitance that has increased by 50 nF from the sensor 130, and the preset value may be 50 nF.

In an embodiment, when the capacitance obtained through the sensor 130 is less than the preset value, the processor 110 may supply power to the induction coil (e.g., the induction coil 124 of FIG. 4) for a first time in operation 503b. For example, as the aerosol generating article 15 is inserted into the housing 100, the processor 110 may obtain a first capacitance from the sensor 130. In this case, when the obtained first capacitance is 30 nF, the processor 110 may detect that the first capacitance is less than 50 nF that is the preset value. Also, when the capacitance obtained through the sensor 130 is less than the preset value, the processor 110 may detect that the aerosol generating article 15 inserted into the housing 100 is in a general state. The processor 110 may supply certain power to the induction coil 124 for a first time (e.g., 30 seconds) based on a detection result.

In an embodiment, when the capacitance obtained through the sensor 130 is greater than or equal to the preset value, the processor 110 may supply power to the induction coil 124 for a second time that is longer than the first time in operation 503c. For example, as the aerosol generating article 15 is inserted into the housing 100, the processor 110 may obtain a second capacitance from the sensor 130. In this case, when the obtained second capacitance is 70 nF, the processor 110 may detect that the second capacitance is greater than 50 nF that is the preset value. Also, when the capacitance obtained through the sensor 130 is greater than or equal to the preset value, the processor 110 may detect that the aerosol generating article 15 inserted into the housing 100 is in an excess moisture state. The processor 110 may supply certain power to the induction coil 124 for a second time (e.g., 40 seconds) that is longer than the first time (e.g., 30 seconds) based on a detection result.

In the present disclosure, the ‘first time’ and the ‘second time’ may mean a preheating time for preheating the aerosol generating article 15 up to a target temperature (e.g., 300° C.).

Although FIG. 6 shows an embodiment in which the same power is supplied to the induction coil 124 for different supply times according to the capacitance obtained through the sensor 130, embodiments are not limited thereto. In another embodiment, the processor 110 may control power supplied to the induction coil 124 differently according to the capacitance obtained through the sensor 130, and a detailed description thereof will be provided below.

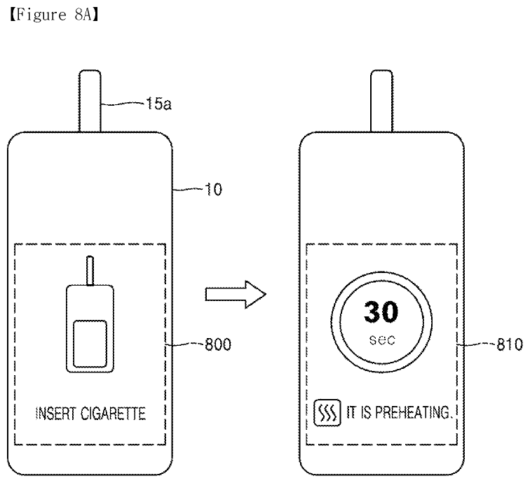

FIG. 7A is an exemplary diagram for explaining a first method of controlling power supply by using an aerosol generating device according to an embodiment.

Referring to FIG. 7A, a processor (e.g., the processor 110 of FIG. 4) of an aerosol generating device (e.g., the aerosol generating device 10 of FIG. 4) may control a power supply time to the induction coil (e.g., the induction coil 124 of FIG. 4) according to the state of the aerosol generating article.

According to graph (a), time reaching the target temperature may be different according to the state (e.g., a general state or an excess moisture state) of the aerosol generating article. For example, when the aerosol generating article is in a general state (700), the aerosol generating article may reach the target temperature faster than a case where the aerosol generating article is in an excess moisture state (710).

In an embodiment, the processor 110 may determine whether the capacitance obtained through the sensor (e.g., the sensor 130 of FIG. 4) is less than a preset value, thereby detecting the state of the aerosol generating article. For example, when the obtained capacitance is less than the preset value, the processor 110 may detect that the state of the aerosol generating article is in the general state (700). In another example, when the obtained capacitance is greater than or equal to the preset value, the processor 110 may detect that the state of the aerosol generating article is in the excess moisture state (710).

According to graphs (b) and (c), the processor 110 may control time reaching the target temperature differently according to the state of the aerosol generating article.

In an embodiment, the processor 110 may control power supply to the induction coil 124 by using a pulse width modulation (PWM) method, as shown in graphs (b) and (c). The PWM method may be a method, whereby a duty ratio is adjusted for a certain period so that power delivered to the induction coil 124 may be controlled.

In an embodiment, when the aerosol generating article is in the general state (700), the processor 110 may control power supply, as shown in graph (b). For example, the processor 110 may control on/off of a switch so that a voltage may be input to the processor 110 for a first time (720) according to a first duty ratio (722). In another embodiment, when the aerosol generating article is in the excess moisture state (710), the processor 110 may control power supply, as shown in graph (c). For example, the processor 110 may control on/off of a switch so that a voltage may be input to the induction coil 124 for a second time (730) according to a second duty ratio (732). In this case, the second time (730) may be longer than the first time (720), and the second duty ratio (732) and the first duty ratio (722) may be the same. Thus, in graphs (b) and (c), average voltage values input to the induction coil 124 may be the same.

FIG. 7B is an exemplary diagram for explaining a second method of controlling power supply by using an aerosol generating device according to an embodiment. In the description of FIG. 7B, the contents corresponding to, the same as or similar to the above-described contents may be omitted.

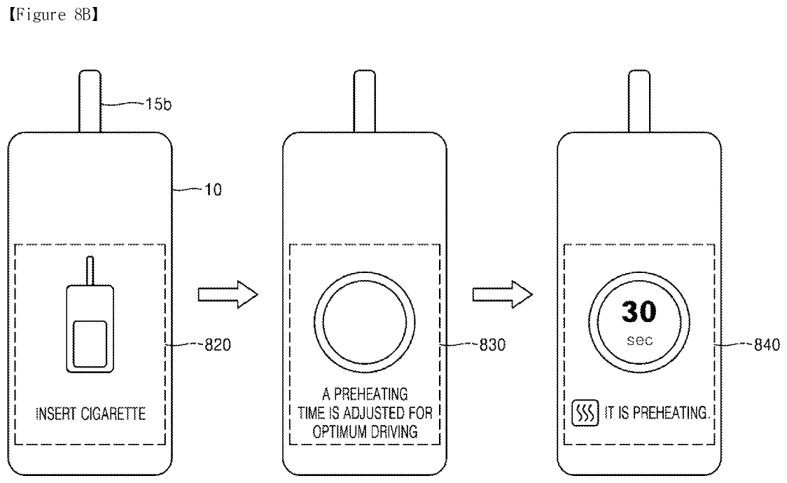

Referring to FIG. 8A, a processor (e.g., the processor 110 of FIG. 4) of an aerosol generating device (e.g., the aerosol generating device 10 of FIG. 4) may control a power supply amount to the induction coil (e.g., the induction coil 124 of FIG. 4) according to the state of the aerosol generating article.

According to graph (a), time reaching the target temperature may be the same according to the state (e.g., a general state, an excess moisture state) of the aerosol generating article. The processor 110 may detect the state of the aerosol generating article based on a capacitance obtained through the sensor 130, as described above in FIG. 7A.

According to graphs (b) and (c), the processor 110 may control time reaching the target temperature differently according to the state of the aerosol generating article.

*112In an embodiment, when the aerosol generating article is in the general state (700), the processor 110 may control power supply, as shown in graph (b). For example, the processor 110 may control on/off of a switch so that a voltage may be input to the induction coil 124 for a third time (740) according to a third duty ratio (750). In another embodiment, when the aerosol generating article is in the excess moisture state (710), the processor 110 may control power supply, as shown in graph (c). For example, the processor 110 may control on/off of a switch so that a voltage may be input to the induction coil 124 for a third time (740) according to a fourth duty ratio (760). In this case, the third duty ratio (750) may be less than the fourth duty ratio (760). For example, the third duty ratio (750) may be 50%, and the fourth duty ratio (760) may be 80%. Thus, an average voltage value input to the induction coil 124 in graph (b) may be less than an average voltage value input to the induction coil 124 in graph (c).

FIGS. 7A and 7B illustrate embodiments in which the processor 110 controls power supply to the induction coil 124 by using a PWM method. However, embodiments are not limited thereto. In another embodiment, the processor 110 may control power supply to the induction coil 124 by using a pulse frequency modulation (PFM) method or a proportional-integral-differential (PID) method.

FIG. 8A is an exemplary diagram illustrating a display state when an aerosol generating article in a general state is inserted into an aerosol generating device according to an embodiment.

Referring to FIG. 8A, a processor (e.g., the processor 110 of FIG. 4) of the aerosol generating device 10 may display an operation user interface (UI) through a display (e.g., the display D of FIG. 1).

For example, when an aerosol generating article 15a in a general state including moisture less than a threshold value (e.g., 15 wt %) in the tobacco rod (e.g., the first portion 300 and the second portion 310) is inserted into the aerosol generating device 10, the processor 110 may display a first UI screen 800 through the display D. The first UI screen 800 may be an UI screen indicating that the aerosol generating article 15a is inserted.

Subsequently, when a preheating start condition is satisfied, the processor 110 may display a second UI screen 810 through the display D. For example, the preheating start condition may be satisfied when a certain time has elapsed from insertion of the aerosol generating article 15a, or when a user input (e.g., a button input) is detected. The second UI screen 810 may be an UI screen including an icon indicating time (e.g., 30 sec) remaining until the preheating of the aerosol generating article 15a is terminated, and a phrase (e.g., “it is preheating”) describing an operation.

FIG. 8B is an exemplary diagram illustrating a display state when an aerosol generating article in an excess moisture state is inserted into an aerosol generating device according to an embodiment.

Referring to FIG. 8B, a processor (e.g., the processor 110 of FIG. 4) of the aerosol generating device 10 may display an operation UI through a display (e.g., the display D of FIG. 1).

For example, when an aerosol generating article 15b in an excess moisture state including moisture greater than or equal to a threshold value (e.g., 15 wt %) in the tobacco rod (e.g., the first portion 300 and the second portion 310 of FIGS. 3A and 3B) is inserted into the aerosol generating device 10, the processor 110 may display a third UI screen 820 through the display D. The third UI screen 820 may be an UI screen indicating that the aerosol generating article 15b is inserted. The third UI screen 820 may be the same as the first UI screen 800 of FIG. 8A.

Subsequently, when a preheating start condition is satisfied, the processor 110 may display a fourth UI screen 830 through the display D. The preheating start condition may be satisfied when a certain time elapsed from insertion of the aerosol generating article 15b, or when a user input (e.g., a button input) is detected. The fourth UI screen 830 may be an UI screen including an icon indicating that a preheating time for the aerosol generating article 15b is being adjusted, and a phrase (e.g., “a preheating time is adjusted for optimum driving.”) describing the operation.

In an embodiment, when the aerosol generating article 15b in an excess moisture state is inserted into the aerosol generating device 10, the aerosol generating article 15b in the excess moisture may be preheated for a time that is substantially longer than the case of the aerosol generating article (e.g., the aerosol generating article 15a) in the general state. For example, the aerosol generating article 15a in the general state may be preheated for about 30 seconds, and the aerosol generating article 15b in the excess moisture state may be preheated for about 40 seconds. In this case, the processor 110 may display the fourth UI screen 830 on the display D for a certain time corresponding to a difference (e.g., 10 seconds) in the preheating time between the aerosol generating article 15a in the general state and the aerosol generating article 15b in the excess moisture state.

In an embodiment, after the time corresponding to the difference in the preheating time has elapsed, the process 110 may display a fifth UI screen 840 on the display D. The fifth UI screen 840 may be an UI screen including an icon indicating time (e.g., 30 seconds) remaining until the preheating of the aerosol generating article 15b is terminated, and a phrase (e.g., “it is preheating.”) describing the operation.

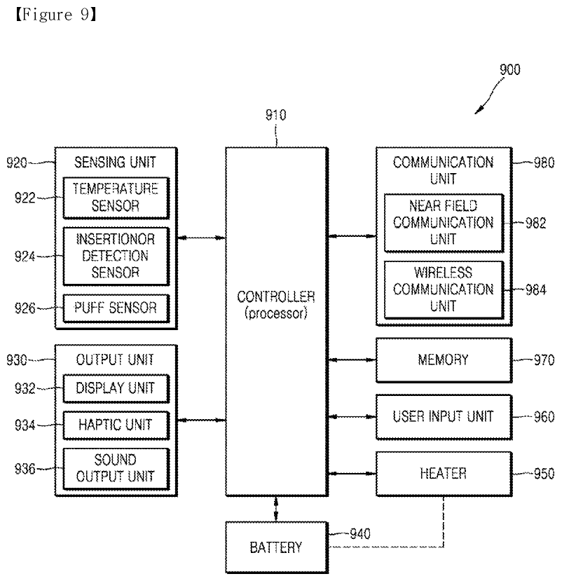

FIG. 9 is a block diagram of an aerosol generating device 900 according to another embodiment.

The aerosol generating device 900 may include a controller 910, a sensing unit 920, an output unit 930, a battery 940, a heater 950, a user input unit 960, a memory 970, and a communication unit 980. However, the internal structure of the aerosol generating device 900 is not limited to those illustrated in FIG. 9. That is, according to the design of the aerosol generating device 900, it will be understood by one of ordinary skill in the art that some of the components shown in FIG. 9 may be omitted or new components may be added.

The sensing unit 920 may sense a state of the aerosol generating device 900 and a state around the aerosol generating device 900, and transmit sensed information to the controller 910. Based on the sensed information, the controller 910 may control the aerosol generating device 900 to perform various functions, such as controlling an operation of the heater 950, limiting smoking, determining whether an aerosol generating article (e.g., a cigarette, a cartridge, or the like) is inserted, displaying a notification, or the like.

The sensing unit 920 may include at least one of a temperature sensor 922, an insertion detection sensor, and a puff sensor 926, but is not limited thereto.

The temperature sensor 922 may sense a temperature at which the heater 950 (or an aerosol generating material) is heated. The aerosol generating device 900 may include a separate temperature sensor for sensing the temperature of the heater 950, or the heater 950 may serve as a temperature sensor. Alternatively, the temperature sensor 922 may also be arranged around the battery 940 to monitor the temperature of the battery 940.

The insertion detection sensor 924 may sense insertion and/or removal of an aerosol generating article. For example, the insertion detection sensor 924 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 926 may sense a user's puff on the basis of various physical changes in an airflow passage or an airflow channel. For example, the puff sensor 926 may sense a user's puff on the basis of any one of a temperature change, a flow change, a voltage change, and a pressure change.

The sensing unit 920 may include, in addition to the temperature sensor 922, the insertion detection sensor 924, and the puff sensor 926 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 930 may output information on a state of the aerosol generating device 900 and provide the information to a user. The output unit 930 may include at least one of a display unit 932, a haptic unit 934, and a sound output unit 936, but is not limited thereto. When the display unit 932 and a touch pad form a layered structure to form a touch screen, the display unit 932 may also be used as an input device in addition to an output device.

The display unit 932 may visually provide information about the aerosol generating device 900 to the user. For example, information about the aerosol generating device 900 may mean various pieces of information, such as a charging/discharging state of the battery 940 of the aerosol generating device 900, a preheating state of the heater 950, an insertion/removal state of an aerosol generating article, or a state in which the use of the aerosol generating device 900 is restricted (e.g., sensing of an abnormal object), or the like, and the display unit 932 may output the information to the outside. The display unit 932 may be, for example, a liquid crystal display panel (LCD), an organic light-emitting diode (OLED) display panel, or the like. In addition, the display unit 932 may be in the form of a light-emitting diode (LED) light-emitting device.

The haptic unit 934 may tactilely provide information about the aerosol generating device 900 to the user by converting an electrical signal into a mechanical stimulus or an electrical stimulus. For example, the haptic unit 934 may include a motor, a piezoelectric element, or an electrical stimulation device.

The sound output unit 936 may audibly provide information about the aerosol generating device 900 to the user. For example, the sound output unit 936 may convert an electrical signal into a sound signal and output the same to the outside.

The battery 940 may supply power used to operate the aerosol generating device 900. The battery 940 may supply power such that the heater 950 may be heated. In addition, the battery 940 may supply power required for operations of other components (e.g., the sensing unit 920, the output unit 930, the user input unit 960, the memory 970, and the communication unit 980) in the aerosol generating device 900. The battery 940 may be a rechargeable battery or a disposable battery. For example, the battery 940 may be a lithium polymer (LiPoly) battery, but is not limited thereto.

The heater 950 may receive power from the battery 940 to heat an aerosol generating material. Although not illustrated in FIG. 9, the aerosol generating device 900 may further include a power conversion circuit (e.g., a direct current (DC)/DC converter) that converts power of the battery 940 and supplies the same to the heater 950. In addition, when the aerosol generating device 900 generates aerosols in an induction heating method, the aerosol generating device 900 may further include a DC/alternating current (AC) that converts DC power of the battery 940 into AC power.

The controller 910, the sensing unit 920, the output unit 930, the user input unit 960, the memory 970, and the communication unit 980 may each receive power from the battery 940 to perform a function. Although not illustrated in FIG. 9, the aerosol generating device 900 may further include a power conversion circuit that converts power of the battery 940 to supply the power to respective components, for example, a low dropout (LDO) circuit, or a voltage regulator circuit.

In an embodiment, the heater 950 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 950 may be implemented by a metal wire, a metal plate on which an electrically conductive track is arranged, a ceramic heating element, or the like, but is not limited thereto.

In another embodiment, the heater 950 may be a heater of an induction heating type. For example, the heater 950 may include a susceptor that heats an aerosol generating material by generating heat through a magnetic field applied by a coil.

The user input unit 960 may receive information input from the user or may output information to the user. For example, the user input unit 960 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 9, the aerosol generating device 900 may further include a connection interface, such as a universal serial bus (USB) interface, and may connect to other external devices through the connection interface, such as the USB interface, to transmit and receive information, or to charge the battery 940.

The memory 970 is a hardware component that stores various types of data processed in the aerosol generating device 900, and may store data processed and data to be processed by the controller 910. The memory 970 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 970 may store an operation time of the aerosol generating device 900, the maximum number of puffs, the current number of puffs, at least one temperature profile, data on a user's smoking pattern, etc.

The communication unit 980 may include at least one component for communication with another electronic device. For example, the communication unit 980 may include a short-range wireless communication unit 982 and a wireless communication unit 984.

The short-range wireless communication unit 982 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 984 may include a cellular network communication unit, an Internet communication unit, a computer network (e.g., local area network (LAN) or wide area network (WAN)) communication unit, or the like, but is not limited thereto. The wireless communication unit 984 may also identify and authenticate the aerosol generating device 900 within a communication network by using subscriber information (e.g., International Mobile Subscriber Identifier (IMSI)).

The controller 910 may control general operations of the aerosol generating device 900. In an embodiment, the controller 910 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 910 may control the temperature of the heater 950 by controlling supply of power of the battery 940 to the heater 950. For example, the controller 910 may control power supply by controlling switching of a switching element between the battery 940 and the heater 950. In another example, a direct heating circuit may also control power supply to the heater 950 according to a control command of the controller 910.

The controller 910 may analyze a result sensed by the sensing unit 920 and control subsequent processes to be performed. For example, the controller 910 may control power supplied to the heater 950 to start or end an operation of the heater 950 on the basis of a result sensed by the sensing unit 920. As another example, the controller 910 may control, based on a result sensed by the sensing unit 920, an amount of power supplied to the heater 950 and the time the power is supplied, such that the heater 950 may be heated to a certain temperature or maintained at an appropriate temperature.

The controller 910 may control the output unit 930 on the basis of a result sensed by the sensing unit 920. For example, when the number of puffs counted through the puff sensor 926 reaches a preset number, the controller 910 may notify the user that the aerosol generating device 900 will soon be terminated through at least one of the display unit 932, the haptic unit 934, and the sound output unit 936.

In an embodiment, the controller 910 may control a power supply time and/or a power supply amount for the heater 950 according to the state of an aerosol generating article (e.g., the aerosol generating article 15 of FIG. 1) sensed by the sensing unit 920. For example, when the aerosol generating article 15 is in an excess moisture state, the controller 910 may control a power supply time for an induction coil (e.g., the induction coil 124 of FIG. 2), thereby increasing a preheating time compared to a case where the aerosol generating article 15 is in a general state.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a housing comprising a chamber configured to accommodate an aerosol generating article;
an induction coil configured to generate a variable magnetic field;
a susceptor arranged to surround at least a portion of the chamber and configured to generate heat by the variable magnetic field;
a sensor spaced apart from the induction coil in a length direction of the housing and arranged in a region in which an intensity of the variable magnetic field is less than or equal to a designated value; and
a processor electrically connected to the induction coil and the sensor.

2. The aerosol generating device of claim 1, wherein the sensor is a capacitive sensor configured to detect a capacitance corresponding to a moisture amount of the aerosol generating article.

3. The aerosol generating device of claim 2, wherein the processor is further configured to obtain the detected capacitance from the sensor and to supply power to the induction coil based on the obtained capacitance.

4. The aerosol generating device of claim 3, wherein the power is supplied to preheat the aerosol generating article.

5. The aerosol generating device of claim 2, wherein the processor is further configured to supply power to the induction coil for a first time when the capacitance is less than a preset value, and to supply the power to the induction coil for a second time that is longer than the first time when the capacitance is greater than or equal to the preset value.

6. The aerosol generating device of claim 5, wherein the preset value is a minimum value of the capacitance indicating an excess moisture state of the aerosol generating article.

7. The aerosol generating device of claim 1, wherein the sensor comprises at least one electrode formed of a metal thin film.

8. The aerosol generating device of claim 1, wherein the sensor is spaced apart from at least one of the susceptor and the induction coil in a first direction parallel to the length direction of the housing or in a second direction opposite to the first direction.

9. The aerosol generating device of claim 1, wherein the sensor is disposed to correspond to at least a portion of the aerosol generating article.

10. The aerosol generating device of claim 1, wherein the sensor is disposed to correspond to at least one of a first portion including an aerosol generating material and a second portion including a tobacco material.

11. A method of operating an aerosol generating device, the method comprising:
obtaining a capacitance corresponding to a moisture amount of an aerosol generating article from a sensor arranged in a region in which an intensity of a variable magnetic field generated by an induction coil is less than or equal to a designated value; and
controlling the aerosol generating device to supply power to the induction coil based on the obtained capacitance.

12. The method of claim 11, wherein the power is supplied to preheat the aerosol generating article.

13. The method of claim 11, wherein the controlling comprises supplying the power to the induction coil for a first time when the capacitance is less than a preset value.

14. The method of claim 13, wherein the controlling comprises supplying the power to the induction coil for a second time that is longer than the first time when the capacitance is greater than or equal to the preset value.

15. The method of claim 13, wherein the preset value is a minimum value of the capacitance indicating an excess moisture state of the aerosol generating article.
